(19) United States
(12) Patent Application Publication
(10) Pub. No.: US 2007/0158008 A1
(43) Pub. Date: Jul. 12, 2007

(54) Pneumatic radial tire for motorcycle

(76) Inventor: Tsutomu Nakamura, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/587,297

(22) PCT Filed: Jan. 24, 2005
(86) PCT No.: PCT/JP05/00865

§ 371 Date: Jul. 26, 2006

(30) Foreign Application Priority Data
Jan. 26, 2004 (JP) 2004-016895

(51) Int. Cl. B60C 9/00

(52) U.S. Cl. 152/527; 152/454; 152/531; 152/538

(57) ABSTRACT

A pneumatic radial tire for a motorcycle capable of increasing steering stability in cornering at high speeds while holding various performances such as high-speed durability and straight running stability. The radial tire including a tread portion 2, side wall portions 3, bead portions 4 is provided with a carcass layer 5 and at least one layer of steel spiral belt 6 formed by spirally winding substantially in parallel with the equatorial plane of the tire. The flatness ratio (SH/TW) of the height (SH) of the tire in cross section to the maximum tread surface width (TW) is in a range from 0.50 to 0.85. Among bending rigidities of the tread portion 2, the lateral out-plane bending rigidity (Sb) is in the range from 4.9 to 7.7 N/mm and the peripheral in-plane bending rigidity (Sa) is in the range from 5.1 to 7.8 N/mm. The belt surface rigidity equilibrium value (K) expressed by a bending rigidity ratio (Sa/Sb) is in a range from 0.90 to 1.10.

### TECHNICAL FIELD

The present invention relates to a pneumatic radial tire for a motorcycle, especially a high performance motorcycle so called super sports type that allows a high speed cornering by contacting the tread contacting face with ground up to a side edge position. More specifically, the present invention relates to a low profile pneumatic radial tire for a high performance motorcycle that improves the steering stability during cornering at high speeds while holding various performances such as high-speed durability and straight running stability.

### BACKGROUND ART

In the cornering of the motorcycle on urban areas, a certain camber angle is given to the tire, that is, camber running is performed by inclining the motorcycle. Generally, it is conducted to contact a tread contacting face with ground by about 50 to 75%, at most, of the entire tread width.

In the general course of developing the pneumatic radial tire for the motorcycle, optimization of various bending rigidities and the balance thereamong of the belt layer which may influence the steering stability at the high speed cornering by largely inclining the motorcycle body while contacting the tread contacting face with ground up to a side edge position has never been considered.

For example, Patent Publication 1 discloses the tire for a motorcycle exhibiting durability and high-speed durability of the belt improved at lower costs, and excellent running stability by enhancing the impact absorption and uniformity of the tire. However, it does not relate to the optimization of various types of bending rigidities of the belt layer for the purpose of improving the steering stability at the high-speed cornering. Patent Publication 1: Patent Application Publication No. 2002-234032 (claims, paragraph [0001] and the like)

### DISCLOSURE OF THE INVENTION

Problem to be Solved by the Invention

In recent year, however, a high performance motorcycle so called super sports type has been made an appearance, increasing number of riders to enjoy sporty driving on freeways. Also special control areas for sporty running rather than usual public roads, such as training fields and circuits allow riders to enjoy drastic sporty running while challenging to a limit of the steering technique. As the sporty running is readily enjoyed, the cornering at a high speed while largely inclining a vehicle body, or so-called large camber running is frequently conducted. In the tires based on the conventional belt design technique and the like, therefore, it is increasing to be a dissatisfaction that the steering stability in the high-speed cornering is lacking in such a large camber running.

It is an object of the present invention to provide a pneumatic radial tire for a motorcycle, which exhibits improved steering stability at the high speed cornering while holding various performances such as high speed durability and straight running stability.

Means for Solving the Problem

As the result of thorough examination with respect to the above-described task, the present invention has been made to achieve the aforementioned object.

That is, a pneumatic radial tire for a motorcycle according to the present invention which includes a tread portion, a pair of sidewall portions extending from edges of the tread portion inward in a radial direction of the tire, and bead portions continued to the side walls inward in the radial direction of the tire is provided with a carcass layer of at least one carcass ply having a cord at an angle in a range from 60 to 90 degrees with respect to an equatorial plane of the tire coated with a rubber material so as to make a reinforcement across bead cores embedded in the bead portions, and at least one layer of a steel spiral belt formed by spirally winding substantially in parallel with the equatorial plane of the tire outward of the carcass layer in the radial direction of the tire. An flatness ratio (SH/TW) of a height SH of cross section of the tire to a maximum width TW of a tread surface upon installation on a measurement rim specified by ETRTO under a no-load state at a post cure inflation in a vulcanizing process of the tire is set to be in a range from 0.50 to 0.85. A lateral out-plane bending rigidity (Sb) and a peripheral in-plane bending rigidity (Sa) among bending rigidities of the tread portion are set to be in ranges from 4.9 to 7.7 N/mm (500 to 790 g/mm), and from 5.1 to 7.8 N/mm (520 to 800 g/mm), respectively, and a belt surface rigidity equilibrium value (K) expressed by a bending rigidity ratio (Sa/Sb) of the peripheral in-plane bending rigidity (Sa) to the lateral out-plane bending rigidity (Sb) is set to be in a range from 0.90 to 1.10.

In the present invention, preferably, a steel cord that forms the steel spiral belt is formed as an open twisting cord with 1×2 structure having a filament diameter set to be in a range from 0.12 to 0.40 mm. In this case, the belt surface rigidity equilibrium value (K) is preferably in a range from 0.96 to 1.06.

Preferably, a steel cord that forms the steel spiral belt comprises an open twisting cord with 1×3 structure having a filament diameter in a range from 0.12 to 0.40 mm. In this case, the belt surface rigidity equilibrium value (K) is preferably in a range from 0.98 to 1.08.

In the invention, a pneumatic radial tire for a motorcycle which includes a tread portion, a pair of sidewall portions extending from edges of the tread portion inward in a radial direction of the tire, and bead portions continued to the side walls inward in the radial direction of the tire is provided with a carcass layer of at least one carcass ply having a cord at an angle in a range from 60 to 90 degrees with respect to an equatorial plane of the tire coated with a rubber material so as to make a reinforcement across bead cores embedded in the bead portions, and at least one layer of a steel spiral belt formed by spirally winding substantially in parallel with the equatorial plane of the tire outward of the carcass layer in the radial direction of the tire. An flatness ratio (SH/TW) of a height SH of cross section of the tire to a maximum width TW of a tread surface upon installation on a measurement rim specified by ETRTO under a no-load state at a post cure inflation in a vulcanizing process of the tire is set to be in a range from 0.50 to 0.85. A steel cord that forms the steel spiral belt comprises an open twisting cord with 1×2 structure having a filament diameter set to be in a range from 0.12 to 0.40 mm.

In the present invention, a pneumatic radial tire for a motorcycle which includes a tread portion, a pair of sidewall portions extending from edges of the tread portion inward in a radial direction of the tire, and bead portions continued to the side walls inward in the radial direction of the tire is provided with a carcass layer of at least one carcass ply having a cord at an angle in a range from 60 to 90 degrees with respect to an equatorial plane of the tire coated with a rubber material so as to make a reinforcement across bead cores embedded in the bead portions, and at least one layer of a steel spiral belt formed by spirally winding substantially in parallel with the equatorial plane of the tire outward of the carcass layer in the radial direction of the tire. An flatness ratio (SH/TW) of a height SH of cross section of the tire to a maximum width TW of a tread surface upon installation on a measurement rim specified by ETRTO under a no-load state at a post cure inflation in a vulcanizing process of the tire is set to be in a range from 0.50 to 0.85. A count of the steel cord of the steel spiral belt on an equatorial plane of the tire is in a range from 20 to 60 pieces/25 mm, and the steel cord diameter is in a range from 0.30 to 1.20 mm.

In the pneumatic radial tire for a motorcycle, preferably, the steel cord that forms the steel spiral belt is formed as an open twisting cord with 1×2 structure having a filament diameter set to be in a range from 0.12 to 0.40 mm. In this case, a count of the steel cord is preferably in a range from 30 to 60 spieces/25 mm.

In the pneumatic radial tire for a motorcycle, preferably, the steel cord that forms the steel spiral belt is formed as an open twisting cord with 1×3 structure having a filament diameter set to be in a range from 0.12 to 0.40 mm. In this case, a count of the steel cord is preferably in a range from 20 to 42 spieces/25 mm.

Further, the present invention provides a method of mounting the pneumatic radial tire according to the present invention on a motorcycle, wherein different types of the steel spiral belts are selected to be combined to form a front wheel tire and a rear wheel tire.

The lateral out-plane bending rigidity (Sb), the peripheral in-plane bending rigidity (Sa) and the belt surface rigidity equilibrium value (K) among various bending rigidities of the tread portion of the low profile pneumatic radial tire for the high performance motorcycle are set to values to be in the specified ranges, respectively for the reasons as described below.

At the cornering of the high performance motorcycle, the front tire is especially likely to have its position changed and to experience repetitive input and output so frequently through such operations as braking before entering the corner, camber running and steering during the cornering, and exit from the corner by straightening the driving position for the high speed straight running. During braking, especially when running while applying the braking force before entering the corner, the operation combined with banking and steering is conducted. It is critical to set the peripheral in-plane bending rigidity (Sa) of the tread portion to the value equal to or larger than 5.1 N/mm (520 g/mm).

During running at the corner where the operation combined with frequent banking and steering is conducted, it is essential to improve the road holding capability by flexibly deforming the crown of the tire toward the direction of the lateral out-plane bending of the tread portion especially when the tire for the motorcycle exhibits the large tread curvature. For this, the lateral out-plane bending rigidity (Sb) of the tread portion has to be kept to the value equal to or smaller than 7.7 N/mm (790 g/mm). However, if it is smaller than 4.9 N/mm (500 g/mm), the absolute value of the lateral out-plane bending rigidity becomes insufficient. If the peripheral in-plane bending rigidity (Sa) is larger than 7.8 N/mm (800 g/mm), the flexible deformation of the crown of the tire based on the above-specified range cannot be achieved. It is essential to set the peripheral in-plane bending rigidity (Sa) to the value equal to or smaller than 7.8 N/mm (800 g/mm).

In the extreme running state while cornering, the rider is required to conduct a series of operations of entering the high speed cornering from the straight driving position for high speed straight running, bank running while largely inclining the body, and straightening the position for straight high speed running again, while switching right and left cornering alternately. In the aforementioned state, as the peripheral in-plane bending rigidity and the lateral out-plane bending rigidity of the tread portion are frequently switched alternately, the contributions thereby are also switched repeatedly. It is therefore essential to set the belt surface rigidity equilibrium value (K) expressed by the bending rigidity ratio (Sa/Sb) with respect to the peripheral in-plane bending rigidity (Sa) and the lateral out-plane bending rigidity (Sb) in the range from 0.90 to 1.10. If such value K deviates from the aforementioned range, fluctuation (fluctuation range) of the surface rigidity equilibrium balance of the tread portion may become excessively large. This may give the rider with discomfort driving feel, resulting in deteriorated high speed cornering performance.

For the same reason as described above, it is essential to set a count of the steel cords of the steel spiral belt of the tire on its equatorial plane to be in the range from 20 to 60 pieces/25 mm. It is also essential to set the steel cord diameter to be in the range from 0.30 to 1.20 mm.

Effect of the Present Invention

The present invention provides a low profile pneumatic radial tire for a high performance motorcycle, which improves the steering stability during the high speed cornering while holding various performances such as the high speed durability and straight running stability.

### BRIEF DESCRIPTION OF THE DRAWINGS

FIG. 1 is a sectional view of a pneumatic radial tire for a motorcycle according to an embodiment of the present invention.

FIG. 2 is an explanatory view showing a position where a measurement sample is cut from the tread portion of a sample tire.

FIG. 3 is an explanatory view showing how the bending rigidity of the cut sample is measured.

### REFERENCE NUMERALS

1 pneumatic radial tire for motorcycle
2 tread portion
3 side wall portion
4 bead portion
5 carcass layer
6 steel spiral belt
7 bead core

### BEST MODE FOR CARRYING OUT THE INVENTION

An embodiment of the present invention will be described referring to the drawings.

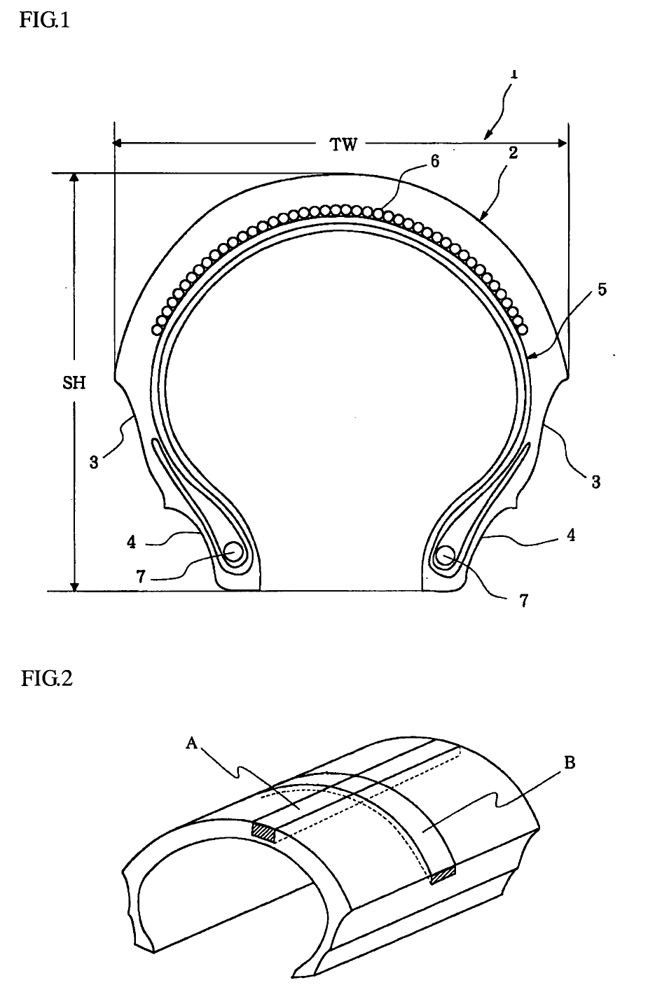

FIG. 1 is a sectional view of a pneumatic radial tire for a motorcycle according to an embodiment of the present invention.

Referring to FIG. 1, the pneumatic radial tire 1 for the motorcycle includes a tread portion 2, a pair of side walls 3 extending inward in the radial direction of the tire from both edges of the tread portion 2, and bead portions 4 continued to the side walls 3 inward in the radial direction of the tire. The aforementioned members are reinforced across bead cores 7 embedded in the bead portions 4 with a carcass layer 5. At least one layer of a steel spiral belt 6 is disposed on the outer surface of the carcass layer 5 in the radial direction of the tire, which is formed by spirally winding substantially in parallel with the equatorial plane of the tire.

The tire according to the present invention is a low profile tire that is appropriately applicable to the high performance motorcycle, which is installed in a measurement rim specified by ETRTO and has a flatness ratio of height SH of cross section of the tire with respect to the tread surface maximum width TW, that is, (SH/TW) to be in the range from 0.50 to 0.85 in the no-load state at the post cure inflation in the vulcanizing process of the tire.

The carcass layer 5 is formed of at least one carcass ply (one layer in the drawing) having its cord angled in the range from 60 to 90 degrees with respect to the equatorial plane coated with a rubber material as shown in the drawing. The organic fiber cord, for example, rayon cord, nylon cord, polyester cord and the like may be employed as the carcass ply cord.

The steel spiral belt 6 is formed of a steel cord and a rubber coating applied thereto, and disposed substantially in parallel with the equatorial plane of the tire 1. The term “substantially” is used to represent the state where the inclined angle of the steel cord with respect to the equatorial plane E is smaller than 1 degree. It is preferable to spirally wind 1 to 5, and more preferably 2 to 4 steel cords around the outer periphery of the carcass layer 5.

In the present invention, preferably the steel cord that forms the steel spiral belt 6 is an open twisting cord with 1×2 structure having the filament diameter in the range from 0.12 to 0.40 mm. This may provide required values of the lateral out-plane bending rigidity (sb), the peripheral in-plane bending rigidity (sa) and the belt surface rigidity equilibrium value (K). The open twisting cord is known as being formed by twisting the excessively reformed filament, which exhibits excellent rubber permeability into the cord.

In the present invention, it is preferable to use an open twisting cord with 1×3 structure having the filament diameter in the range from 0.12 to 0.40 mm as the steel cord that forms the steel spiral belt 6. This may provide required values of the lateral out-plane bending rigidity (Sb), the peripheral in-plane bending rigidity (Sa), and the belt surface rigidity equilibrium value (K), respectively.

In the present invention, the count of the steel cord of the steel spiral belt 6 on the equatorial plane of the tire is in the range from 20 to 60 spieces/25 mm, and the diameter of the steel cord is in the range from 0.30 to 1.20 mm. Preferably, the steel cord that forms the steel spiral belt 6 is an open twisting cord with 1×2 structure having a filament diameter in the range from 0.12 to 0.40 mm. In this case, it is preferable to set the count of the steel cords on the equatorial plane of the tire having the same steel cord diameter to the value in the range from 30 to 60 spieces/25 mm. Preferably the steel cord that forms the steel spiral belt 6 is an open twisting cord with 1×3 structure having a filament diameter in the range from 0.12 to 0.40 mm. In this case, it is preferable to set the count of the steel cords on the equatorial plane having the same steel cord diameter to the value in the range from 20 to 42 spieces/25 mm. This makes it possible to provide required values of the lateral out-plane bending rigidity (Sb), the peripheral in-plane bending rigidity (Sa), and the belt surface rigidity equilibrium value (K).

Examples

Examples of the present invention will be described.

The front wheel tire (size:120/70ZR17, rim width:3.50 inches, inner pressure:206 kPa) and the rear wheel tire (size:190/55ZR17, rim width:6.00 inches, inner pressure: 186 kPa) which satisfy the conditions shown in Tables 1 and 2 were combined in accordance with the combinations shown in Table 3. They were installed in the racer type motorcycle of 500 cc displacement such that the steering stability feeling at the high speed cornering was evaluated. The resultant evaluations are shown as the index with respect to the FIG. 100 of the comparative example 3. As the value becomes larger, the result will be better.

The peripheral in-plane bending rigidity (Sa) and the lateral out-plane bending rigidity (Sb) shown in Tables 1 and 2 were measured in the following process.

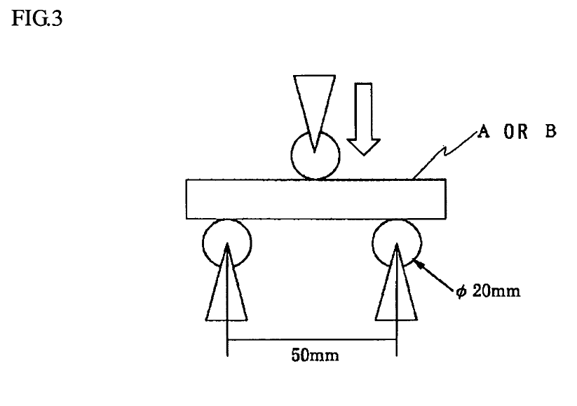

The road contact portion of the sample tire having no pattern groove and the tread rubber with the same thickness was cut along the equatorial plane direction and in the direction at 90 degrees with respect to the equatorial plane to provide measurement samples each having a width of 15 mm together with the belts (See A and B in FIG. 2). Referring to FIG. 3, the sample (A) cut along the equatorial direction had its position shifted at 90 degrees so as to be set on the measurement device, and depressed in the direction corresponding to the axial direction of the tire such that the peripheral in-plane bending rigidity (Sa) is measured. The sample (B) cut in the direction at 90 degrees with respect to the equatorial plane is set on the measurement device, and depressed in the direction corresponding to the radial direction of the tire such that the lateral out-plane bending rigidity (Sb) is measured. The rigidity values (force/regeneration) were measured, and the resultant measurements are shown in Tables 1 and 2.

TABLE 1

| | | Front wheel tire | | |
|---|---|---|---|---|
| | | | | Conventional |
| | | Example 1 | Example 2 | example 1 |
| Flatness ratio | | 0.70 | 0.70 | 070 |
| (SH/TW) | | | | |
| Carcass layer | Carcass ply | 1 layer | 1 layer | 1 layer |
| | Cord type | Nylon cord | Nylon cord | Nylon cord |
| | Angle(to | 90 degrees | 90 degrees | 90 degrees |
| | peripheral | | | |
| | direction) | | | |
| Belt | Number of belt | 1 layer | 1 layer | 1 layer |
| | layer | | | |
| | Cord structure | 1 × 2 × 0.2(mm) | 1 × 3 × 0.2(mm) | 1 × 5 × 0.2(mm) |
| | Angle(to | Substantially | Substantially | Substantially |
| | peripheral | in peripheral | in peripheral | in peripheral |
| | direction) | direction | direction | direction |
| | Cord size(mm)* | 0.75 | 0.75 | 0.75 |
| | Ends | 38/25 mm | 25/25 mm | 15/25 mm |

| | | | |
|---|---|---|---|
| Peripheral in-plane | 6.54 N/mm | 6.30 N/mm | 6.75 N/mm |
| bending rigidity (Sa) | (667 g/mm) | (642 g/mm) | (688 g/mm) |
| Lateral out-plane | 6.49 N/mm | 6.10 N/mm | 6.10 N/mm |
| bending rigidity (Sb) | (662 g/mm) | (622 g/mm) | (622 g/mm) |
| Belt surface rigidity | 1.01 | 1.03 | 1.11 |
| equilibrium value (K) | | | |

*The apparent (projection) diameter of the belt cord is the same as the theoretical figure owing to open cord.

TABLE 2

| | | Front wheel tire | | |
|---|---|---|---|---|
| | | | | Conventional |
| | | Example 3 | Example 4 | example 2 |
| Flatness ratio | | 0.70 | 0.70 | 070 |
| (SH/TW) | | | | |
| Carcass layer | Carcass ply | 1 layer | 1 layer | 1 layer |
| | Cord type | Nylon cord | Nylon cord | Nylon cord |
| | Angle(to | 90 degrees | 90 degrees | 90 degrees |
| | peripheral | | | |
| | direction) | | | |
| Belt | Number of belt | 1 layer | 1 layer | 1 layer |
| | layer | | | |
| | Cord structure | 1 × 2 × 0.2(mm) | 1 × 3 × 0.2(mm) | 1 × 5 × 0.2(mm) |
| | Angle(to | Substantially | Substantially | Substantially |
| | peripheral | in peripheral | in peripheral | in peripheral |
| | direction) | direction | direction | direction |
| | Cord size(mm)* | 0.75 | 0.75 | 0.75 |
| | Ends | 50/25 mm | 35/25 mm | 20/25 mm |

| | | | |
|---|---|---|---|
| Peripheral in-plane | 6.54 N/mm | 6.30 N/mm | 6.75 N/mm |
| bending rigidity (Sa) | (667 g/mm) | (642 g/mm) | (688 g/mm) |
| Lateral out-plane | 6.49 N/mm | 6.10 N/mm | 6.10 N/mm |
| bending rigidity (Sb) | (662 g/mm) | (622 g/mm) | (622 g/mm) |
| Belt surface rigidity | 1.01 | 1.03 | 1.11 |
| equilibrium value (K) | | | |

*The apparent (projection) diameter of the belt cord is the same as the theoretical figure owing to open cord.

TABLE 3

Combination of
front and rear wheel tires

| | | | Conventional |
|---|---|---|---|
| | Example 5 | Example 6 | example 3 |
| Front wheel tire | Example 1 | Example 2 | Conventional |
| | | | example 1 |
| Rear wheel tire | Example 3 | Example 4 | Conventional |
| | | | example 2 |
| Steering stability | 120 | 110 | 100 |
| at high-speed | | | |
| cornering (index) | | | |

1. A pneumatic radial tire for a motorcycle including a tread portion, a pair of sidewall portions extending from edges of the tread portion inward in a radial direction of the tire, and bead portions continued to the side walls inward in the radial direction of the tire, provided with a carcass layer of at least one carcass ply having a cord at an angle in a range from 60 to 90 degrees with respect to an equatorial plane of the tire coated with a rubber material so as to make a reinforcement across bead cores embedded in the bead portions, and at least one layer of a steel spiral belt formed by spirally winding substantially in parallel with the equatorial plane of the tire outward of the carcass layer in the radial direction of the tire, wherein:
a flatness ratio (SH/TW) of a height SH of cross section of the tire to a maximum width TW of a tread surface upon installation on a measurement rim specified by ETRTO under a no-load state at a post cure inflation in a vulcanizing process of the tire is set to be in a range from 0.50 to 0.85; and
a lateral out-plane bending rigidity (Sb) and a peripheral in-plane bending rigidity (Sa) among bending rigidities of the tread portion are set to be in ranges from 4.9 to 7.7 N/mm (500 to 790 g/mm), and from 5.1 to 7.8 N/mm (520 to 800 g/mm), respectively, and a belt surface rigidity equilibrium value (K) expressed by a bending rigidity ratio (Sa/Sb) of the peripheral in-plane bending rigidity (Sa) to the lateral out-plane bending rigidity (Sb) is set to be in a range from 0.90 to 1.10.

2. The pneumatic radial tire for a motorcycle according to claim 1, wherein a steel cord that forms the steel spiral belt comprises an open twisting cord with 1×2 structure having a filament diameter in a range from 0.12 to 0.40 mm.

3. The pneumatic radial tire for a motorcycle according to claim 2, wherein the belt surface rigidity equilibrium value (K) is in a range from 0.96 to 1.06.

4. The pneumatic radial tire for a motorcycle according to claim 1, wherein a steel cord that forms the steel spiral belt comprises an open twisting cord with lx3 structure having a filament diameter in a range from 0.12 to 0.40 mm.

5. The pneumatic radial tire for a motorcycle according to claim 4, wherein the belt surface rigidity equilibrium value (K) is in a range from 0.98 to 1.08.

6. A pneumatic radial tire for a motorcycle including a tread portion, a pair of sidewall portions extending from edges of the tread portion inward in a radial direction of the tire, and bead portions continued to the side walls inward in the radial direction of the tire, provided with a carcass layer of at least one carcass ply having a cord at an angle in a range from 60 to 90 degrees with respect to an equatorial plane of the tire coated with a rubber material so as to make a reinforcement across bead cores embedded in the bead portions, and at least one layer of a steel spiral belt formed by spirally winding substantially in parallel with the equatorial plane of the tire outward of the carcass layer in the radial direction of the tire, wherein:
a flatness ratio (SH/TW) of a height SH of cross section of the tire to a maximum width TW of a tread surface upon installation on a measurement rim specified by ETRTO under a no-load state at a post cure inflation in a vulcanizing process of the tire is set to be in a range from 0.50 to 0.85; and
a steel cord that forms the steel spiral belt comprises an open twisting cord with 1×2 structure having a filament diameter set to be in a range from 0.12 to 0.40 mm.

7. The pneumatic radial tire for a motorcycle according to claim 6, wherein a count of the steel cord is in a range from 30 to 60 pieces/25 mm.

8. The pneumatic radial tire for a motorcycle according to claim 7, wherein a lateral out-plane bending rigidity (Sb) and a peripheral in-plane bending rigidity (Sa) among bending rigidities of the tread portion are set to be in ranges from 4.9 to 7.7 N/mm (500 to 790 g/mm), and from 5.1 to 7.8 N/mm (520 to 800 g/mm), respectively, and a belt surface rigidity equilibrium value (K) expressed by a bending rigidity ratio (Sa/Sb) of the peripheral in-plane bending rigidity (Sa) to the lateral out-plane bending rigidity (Sb) is set to be in a range from 0.96 to 1.06.

9. A pneumatic radial tire for a motorcycle including a tread portion, a pair of sidewall portions extending from edges of the tread portion inward in a radial direction of the tire, and bead portions continued to the side walls inward in the radial direction of the tire, provided with a carcass layer of at least one carcass layer having a cord at an angle in a range from 60 to 90 degrees with respect to an equatorial plane of the tire coated with a rubber material so as to make a reinforcement across bead cores embedded in the bead portions, and at least one layer of a steel spiral belt formed by spirally winding substantially in parallel with the equatorial plane of the tire outward of the carcass layer in the radial direction of the tire, wherein:
a flatness ratio (SH/TW) of a height SH of cross section of the tire to a maximum width TW of a tread surface upon installation on a measurement rim specified by ETRTO under a no-load state at a post cure inflation in a vulcanizing process of the tire is set to be in a range from 0.50 to 0.85; and
a count of the steel cord of the steel spiral belt on an equatorial plane of the tire is in a range from 20 to 60 pieces/25 mm, and the steel cord diameter is in a range from 0.30 to 1.20 mm.

10. The pneumatic radial tire for a motorcycle according to claim 9, wherein the steel cord that forms the steel spiral belt comprises an open twisting cord with 1×2 structure having a filament diameter set to be in a range from 0.12 to 0.40 mm.

11. The pneumatic radial tire for a motorcycle according to claim 10, wherein a count of the steel cord is in a range from 30 to 60 pieces/25 mm.

12. The pneumatic radial tire for a motorcycle according to claim 9, wherein the steel cord that forms the steel spiral belt comprises an open twisting cord with 1×3 structure having a filament diameter set to be in a range from 0.12 to 0.40 mm.

13. The pneumatic radial tire for a motorcycle according to claim 12, wherein a count of the steel cord is in a range from 20 to 42 pieces/25 mm.

14. A method of mounting a pneumatic radial tire according to on a motorcycle, wherein different types of the steel spiral belts are selected to be combined to form a front wheel tire and a rear wheel tire.
